(19) United States
(12) Patent Application Publication
(10) Pub. No.: US 2022/0209628 A1
(43) Pub. Date: Jun. 30, 2022

(54) Electric Machine

(71) Applicant: Siemens Aktiengesellschaft, München (DE)

(72) Inventor: Frank Brütting, Erlangen (DE)

(73) Assignee: Siemens Aktiengesellschaft, München (DE)

(21) Appl. No.: 17/601,117

(22) PCT Filed: Feb. 26, 2020
(86) PCT No.: PCT/EP2020/054987

§ 371 Date: Oct. 4, 2021

(30) Foreign Application Priority Data
Apr. 4, 2019 (EP) 19167289.8

(51) Int. Cl. H02K 9/22; H02K 3/12; H02K 3/28; H02K 11/33

(52) U.S. Cl. CPC H02K 9/227; H02K 3/12; H02K 15/085; H02K 11/33; H02K 2203/03; H02K 3/28

(57) ABSTRACT

Various embodiments include an electric machine with: a stator with a plurality of grooves for receiving a stator winding wherein a respective conductor section of the stator winding is inserted into each groove of the plurality of grooves. The respective conductor sections of a pole pair are short-circuited with one another on a first side of the stator. Each of the conductor sections is connected on a second side of the stator opposite the first side to a connection of a power supply unit. The power supply unit comprises two conductors electrically connected to an electronic power component. The electronic power component is arranged on a cooling body at least partially covering the second side of the stator.

### CROSS-REFERENCE TO RELATED APPLICATIONS

This application is a U.S. National Stage Application of International Application No. PCT/EP2020/054987 filed Feb. 26, 2020, which designates the United States of America, and claims priority to EP Application No. 19167289.8 filed Apr. 4, 2019, the contents of which are hereby incorporated by reference in their entirety.

### TECHNICAL FIELD

The present disclosure relates to electric machines. Various embodiments of the teachings herein include an electric machine having a stator.

### BACKGROUND

A stator has electrical windings which are connected to a current system which is frequently multi-phase. Distributed windings are mostly used for applications with more than two coils per pole per phase. The main advantage of the distributed windings is that the magnetomotive force in the air gap between a stator and a rotor of the machine, said rotor being mounted in such a manner as to be able to move with respect to the stator, has fewer harmonics, in other words a lower proportion of undesired harmonics of the magnetomotive force. This results in a highly efficient machine that can be operated as a motor or generator, with low rotor losses, low noise, and few vibration problems. A disadvantage of the distributed winding, however, is the complex production.

In order to combine an electric machine having good electrical properties of a distributed winding with the advantage of low manufacturing costs, DE 10 2014 113 489 A1 suggests, in the case of a machine having a stator that comprises a plurality of grooves that are formed between adjacent teeth of the stator and serve to accommodate a stator winding, to insert a conductor section of the stator winding into each groove. In this case, the conductor sections of at least one pole pair are short circuited with one another on a first side of the stator. On a second side of the stator that lies opposite the first side, the free ends of the conductor sections are connected to a connection of a power supply unit. The power supply unit comprises two electrical conductors. In order to be able to dissipate the heat loss from the semiconductor switches and other components of the electronic power component, active cooling is provided in that an annular cooling channel is provided so as to guide a fluid and the electronic power components are arranged on said cooling channel. It is provided that the cooling channel is provided in or between the two conductors that are arranged in an annular manner. This results in a complex production.

### SUMMARY

The teachings of the present disclosure describe various improvements to an electric machine having good electrical properties of a distributed winding and good cooling with the advantage of low manufacturing costs. For example, some embodiments include an electric machine having a stator, wherein the stator comprises a plurality of grooves for receiving a stator winding; a conductor section of the stator winding is inserted into each groove; the conductor sections of at least one pole pair are short-circuited with one another on a first side of the stator; the conductor sections are connected on a second side of the stator that lies opposite the first side, in each case to a connection of a power supply unit; the power supply unit comprises at least two conductors (17, 18) that are electrically connected to at least one electronic power component (1); the at least one electronic power component (1) is arranged on the cooling body (10); characterized in that the cooling body (10) is embodied essentially in a disk-shaped manner and covers the second side of the stator over a large area.

In some embodiments, the cooling body (10) comprises at least one fluid channel (14) for conveying a fluid.

In some embodiments, the at least two conductors (17, 18) are embodied at least in sections in an annular manner.

In some embodiments, the at least one of the at least two conductors (17, 18) is arranged on the cooling body (10).

In some embodiments, at least one of the at least two conductors (17, 18) is arranged together with the at least one electronic power component (1) on a first side (11) of the cooling body (10).

In some embodiments, at least one of the at least two conductors (17, 18) is arranged on a second side (12) of the cooling body (10) that lies opposite the first side (11).

In some embodiments, the cooling body (10) forms one of the at least two conductors (17, 18).

In some embodiments, the electronic power component (1) comprises a single layer or multi-layer printed circuit board (6) having at least one semiconductor switch (2, 3) and an optional driver circuit (4).

In some embodiments, at least one of the at least two conductors (17, 18) is arranged on the printed circuit board (6).

In some embodiments, the at least one semiconductor switch (2, 3) and the optional driver circuit (5) are arranged on and/or in the printed circuit board (6).

In some embodiments, the at least one semiconductor switch (2, 3) and/or the driver circuit (5) is embodied as a surface mountable component.

In some embodiments, the printed circuit board (6) forms at least a part of the cooling body (10).

In some embodiments, the printed circuit board (6) is provided with at least one cooling groove (16) that is open on one side, wherein the printed circuit board (6) is connected on the side that has the cooling groove (16) that is open on at least one side to a counter plate (24).

In some embodiments, the conductor sections (20) are increased in length by an assigned cut-out (15) in the cooling body (10) and in the printed circuit board (6) in order to be electrically connected on the side of the cooling body (10) that is facing away from the stator to the at least one electronic power component (1).

In some embodiments, the conductor sections (20) are connected by an, in particular central, inner hole (13) of the cooling body (10) and/or outside the outer circumference of the cooling body (10) by way of in each case connecting pieces to the at least one electronic power component (1).

In some embodiments, the cooling body (10) has a plurality of segments, wherein the number of segments corresponds in particular to the number of phases.

In some embodiments, a respective electronic power component (1) is embodied so as to control one or more phases.

### BRIEF DESCRIPTION OF THE DRAWINGS

Further details and embodiments are described in more detail below in multiple exemplary embodiments with reference to the figures. In the drawings:

FIG. 1 shows a plan view of a first exemplary embodiment of an electronic power component incorporating teachings of the present disclosure that is attached to a cooling disk that is embodied as a cooling body;

FIG. 2 shows a cross-sectional view along the line II-II of the arrangement shown in FIG. 1;

FIG. 3 shows a cross-sectional view of a second exemplary embodiment incorporating teachings of the present disclosure in which multiple electronic power components are arranged on a cooling body that is embodied as a cooling disk;

FIG. 4 shows a cross-sectional view of a third exemplary embodiment incorporating teachings of the present disclosure in which multiple electronic power components are arranged on a cooling body that is embodied as a cooling disk;

FIG. 5 shows a cross-sectional view of a fourth exemplary embodiment incorporating teachings of the present disclosure in which multiple electronic power components are arranged on a cooling body that is embodied as a cooling disk;

FIG. 6 shows a cross-sectional view of a fifth exemplary embodiment incorporating teachings of the present disclosure in which multiple electronic power components are arranged on a cooling body that is embodied as a cooling disk;

FIG. 7 shows a cross-sectional view through the left-hand part of the fifth exemplary embodiment incorporating teachings of the present disclosure, wherein a printed circuit board is part of the cooling body in accordance with a first variant;

FIG. 8 shows a cross-sectional view through the left-hand part of the fifth exemplary embodiment, wherein a printed circuit board is part of the cooling body in accordance with a second variant;

FIG. 9 shows an exploded perspective view of conductor sections, annular conductors and a power electronic module of a sixth exemplary embodiment incorporating teachings of the present disclosure without an illustrated cooling body;

FIG. 10 shows a cross-sectional view through a part of the exemplary embodiment, illustrated in FIG. 9, of the arrangement of the cooling body, annular conductors and the power electronic module;

FIG. 11 shows an exploded perspective view that illustrates the planar arrangement of power electronic modules and annular conductors on a cooling body in accordance with a seventh exemplary embodiment incorporating teachings of the present disclosure;

FIG. 12 shows a sectional view through the arrangement illustrated in FIG. 11;

FIG. 13 shows a perspective view of an eighth exemplary embodiment incorporating teachings of the present disclosure in which the two conductors are embodied as two adjacent conductor sections that connect power electronic modules;

FIG. 14 shows a cross-sectional view of an electronic power component in a multi-layer design incorporating teachings of the present disclosure; and

FIG. 15 shows a cross-sectional view of the arrangement of the electronic power component that is illustrated in FIG. 14 in relation to a cooling body and conductors of the power supply unit.

### DETAILED DESCRIPTION

In some embodiments, there is an electric machine having a stator. The stator comprises a plurality of grooves which are formed between adjacent teeth of the stator. The grooves serve to receive a stator winding. A conductor section of the stator winding is inserted into each groove. The conductor sections of at least one pole pair are short-circuited with one another on a first side of the stator. On a second side of the stator that lies opposite the first side, the free ends of the conductor sections are connected to a connection of a power supply unit. The power supply unit comprises at least two conductors which are electrically connected to at least one electronic power component. The electronic power component is assigned to one or more conductor sections. The at least one electronic power component is arranged on a cooling body, wherein the cooling body is essentially embodied in a disk-shaped manner and covers the second side of the stator over a large area.

In some embodiments, a large-area cooling body can cover the second side of the stator, in other words is arranged on the end face of the stator, and serve as a carrier for the electronic power component. This ensures simplified and efficient cooling of the at least one electronic power component, which renders it possible to produce the machine with little manufacturing effort.

The stator-side windings as described in the introduction may be replaced by a single bar winding, which is simplified to the extent that it has conductor sections per groove and thus the conductor sections can, for example, be configured essentially in a straight line in the axial direction. In this case, high currents at low voltage can be used in order to achieve a magnetomotive force of the same order of magnitude as in conventional machines having a distributed winding.

The integration of the power electronics, which comprises the at least one electronic power component, can be realized in a simple manner by the arrangement on the disk-shaped and thus flat cooling body, which in particular results in a particularly compact construction of the electrical machine.

An essentially disk-shaped design of the cooling body is to be understood as meaning not only circular but also polygonal edge contours. The edge contour can thus have a number of corners, with the result that the edge contour has a square, a pentagon, a hexagon shape, etc. Generally, the number of corners is greater than or equal to four.

The cooling body may be manufactured from a non-magnetic material. The material used for the cooling body may not be electrically conductive.

In some embodiments, each electronic power component makes contact with one conductor section (that is embodied as a single rod). Consequently, one electronic power component is used to electrically feed one conductor section. A plurality of electronic power components can also be provided, which are distributed along the circumference of the stator on the cooling body. The cooling body can expediently comprise at least one fluid channel for guiding a fluid. The at least one fluid channel is arranged in the cooling body in such a manner that, in particular, the heat generated by the electronic power component can be dissipated efficiently.

In some embodiments, at least two conductors are embodied in an annular manner. This renders it possible, particularly when a large number of electronic power components are provided, to apply respective voltage potentials to them in a simple manner.

In some embodiments, at least one of the at least two conductors is arranged on the cooling body. If the cooling body is manufactured from an insulating material, it is not necessary to provide any special insulating measures.

In some embodiments, at least one of the at least two conductors is arranged together with the at least one electronic power component on a first side of the cooling body. In some embodiments, at least one of the at least two conductors can be arranged on a second side of the cooling body that lies opposite the first side. Arrangements are thus possible whereby the at least two conductors are arranged on the side of the cooling body that faces the stator. In some embodiments, at least two conductors are arranged on the side of the cooling body that is facing away from the stator. A variant is also possible in which one of the conductors is arranged on the side of the cooling body that is facing the stator and the other of the two conductors is arranged on the side of the cooling body that is facing away from the stator. Which variant is chosen may depend in particular upon the prevailing space conditions.

In some embodiments, the cooling body forms one of the at least two conductors. As a result, a larger area proportion can be provided for the at least one electronic power component on the area of the cooling body. In this case, the cooling body must be realized in an electrically isolated manner from the components attached to it.

In some embodiments, an electronic power component comprises a single-layer or multi-layer printed circuit board (in particular in the form of a metal substrate printed circuit board) having at least one semiconductor switch and an optional driver circuit. In addition, the electronic power component can comprise further electronic components, such as at least one capacitor. The driver circuit and the further electronic components can also be arranged on one or more other printed circuit boards.

In some embodiments, at least one of the at least two conductors is arranged on the printed circuit board. For example, the printed circuit board can then be used as an insulating body with respect to the cooling body.

In some embodiments, the at least one semiconductor circuit and the optional driver circuit are arranged on and/or in the printed circuit board. In particular in the case of a variant in which the at least one semiconductor circuit and the optional driver circuit (and the optionally further) existing electronic components are arranged in the printed circuit board, the outer surfaces can be used over a large area for contacting the at least two conductors. As a consequence, small specific currents can be achieved per area.

In some embodiments, the at least one semiconductor switch and/or the optional driver circuit are embodied as a surface-mountable component. This allows the electronic power component to be provided with compact dimensions. In particular, no discrete power electronic modules which require a relatively large amount of space are required.

In some embodiments, the printed circuit board forms at least part of the cooling body. For this purpose, the printed circuit board can be provided with at least one cooling groove that is open on one side so as to form the at least one fluid channel, wherein the printed circuit board is connected to a counter plate on the side that has the at least one cooling groove open that is open on one side. The counter plate can optionally have cooling grooves which are open on one side and which are arranged in a corresponding manner with respect to the cooling grooves of the printed circuit board. As a result, the arrangement of the cooling body, power electronics and power distribution can be realized in a compact manner.

In some embodiments, the conductor sections are increased in length by an associated cut-out in the cooling body and in the printed circuit board in order to be electrically connected on the side of the cooling body that is facing away from the stator to the at least one electronic power component. This embodiment renders possible a simple electrical connection of the power electronics to the conductor sections that lead out in a straight line in the axial direction on the second side of the rotor.

In some embodiments, the conductor sections can be connected to the at least one electronic power component by a, in particular, central, inner hole in the cooling body and/or outside the outer circumference of the cooling body by way of respective connecting pieces.

In some embodiments, the cooling body has a plurality of segments. In particular, it can be provided in this case that the number of segments corresponds in particular to the number of phases. As a result, particularly effective cooling of the power electronics can be provided.

In some embodiments, a respective electronic power component is embodied so as to control one or more phases. One of the two, in particular annular, conductors can realize a positive electrical DC voltage supply. Another one of the two, in particular annular, conductors can realize a negative electrical DC voltage supply. This can be understood as a DC bus. If for example a third conductor is provided, then this can have an intermediate potential.

In some embodiments, the semiconductor switches of a respective electronic power component are connected so as to form a half bridge. If the electronic power component optionally has a capacitor, this can be embodied as an intermediate circuit capacitor or as part of a distributed intermediate circuit or a distributed intermediate circuit capacitance. In this case, it is possible to provide a series and/or parallel connection of multiple capacitors to a support matrix that is lying therebetween and is embodied from conductive and non-conductive elements.

The power supply unit can supply one conductor section each with its own electrical phase by means of the respective electronic power component.

The electrical machines described herein may have benefits related to electromagnetic compatibility, since no alternating current lines that are affected by harmonic waves have to be laid. There is also no need for a separate converter housing. No cables are necessary between separate power electronics and the actual electric machine, since the power electronics are placed in lieu of the winding head that is present in the case of conventional machines. The number of the phases can be for example three, four, five or at least ten.

In order to realize a particularly small manufacturing outlay, it is possible to embody the conductor sections in a straight manner. The conductor sections can be for example aluminum rods, cooper rods or bronze rods or alloys thereof.

In the examples described below, the same reference numerals denote the same elements, wherein the views are not illustrated true to scale.

The drawings illustrate different variants of the arrangement of power electronics and a cooling body for an electrical machine that is known in principle, as defined in the introduction to the description. Such an electric machine, the basic principle of which is known from DE 10 2014 113 489 A1, for example, comprises a stator. The stator has grooves that are distributed along its circumference and extend in a straight line in an axial direction of the stator. A conductor section 20 (FIGS. 2, 9, 10 and 12) is inserted into each groove. The conductor sections of at least one pole pair are for example short-circuited with one another in a short circuit ring on a first side.

Each conductor section 20 can be assigned an electronic power component 1, as will be described in detail below, which is arranged on an essentially disk-shaped and, in this case as an example, circular cooling body on a second side of the stator that is lying opposite the first side. This second side of the stator is also connected to a power supply unit which, for example, comprises two, preferably at least in sections, annular conductors 17, 18 that are electrically connected to the number of electronic power components 1. Each electronic power component 1 is constructed as a module and comprises at least one half bridge, as will be explained in more detail later.

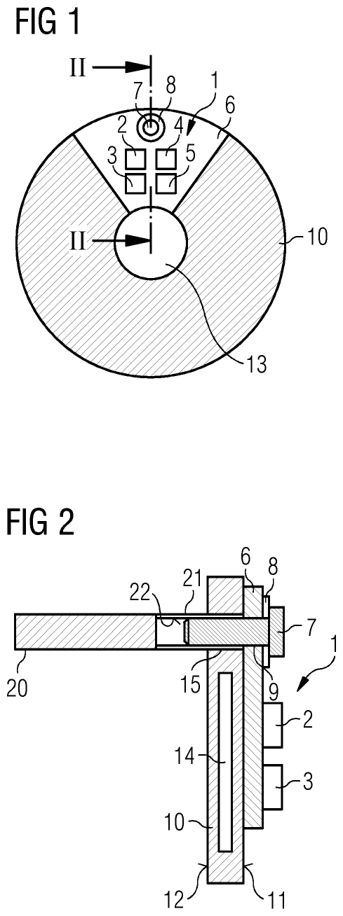

FIG. 1 illustrates a plan view of a disk-shaped cooling body 10 that covers the second side of the stator over a large area. The term “large area” is to be understood in this case to mean that the area that is occupied by the cooling body 10 corresponds approximately to the end-side area of the stator on the second side, on which the conductor sections are guided out of the grooves essentially in a straight line in the axial direction (not shown in FIG. 1). In this case, the conductor rods penetrate a bearing shield that is not illustrated.

The disk-shaped cooling body 10 has for example a central cut-out 13 that is referred to below as an inner hole. A number of power electronic modules 1 are provided on the first side 11 of the cooling body that is facing away from the stator. The number of electronic power components 1 that are embodied in a modular form can be one or more, wherein the number depends upon the number of the conductor sections and the phase that is to be formed and upon the topology of the end stage. In the exemplary embodiment illustrated in FIG. 1, it is possible for example to arrange six electronic power components 1 adjacent to one another over the entire circumference of the disk-shaped cooling body 10. For the sake of simplicity, only one electronic power component 1 is illustrated, wherein its construction is fundamentally identical.

The electronic component 1 comprises a first semiconductor switch 2, a second semiconductor switch 3, an optional driver circuit and an optional electronic component 5, for example a capacitor. The semiconductor switches are in particular power semiconductors, for example IGBTs, MOSFETs, JFETs and the like. Depending on the interconnection, the electronic component 1 can additionally comprise diodes, not illustrated. The semiconductor switches 2, 3 are connected as a half bridge, for example. The capacitor 5 can represent for example an intermediate circuit capacitor of the half bridge.

The semiconductor switches 2, 3, the optional driver circuit 4 and the electronic component 5 are arranged on a printed circuit board 6, which consists of a carrier plate and a conducting track structure. The conducting track structure is not illustrated in FIG. 1 for the sake of clarity.

The electronic power component 1 is mechanically connected to the cooling body 10 by way of its printed circuit board 6. The mechanical fastening that is performed by way of a screw 7 in the exemplary embodiment illustrated here simultaneously electronically contacts a conductor section 20 that is assigned to the electronic power component 1 (cf. FIG. 2). The conductor section 20 is embodied as an individual rod. Although only a single conductor section 20 is shown in FIGS. 1 and 2, the electronic power component 1 can be mechanically and electrically connected to a plurality of conductor sections 20 in the design described below.

The screw 7 engages through a recess 9 in the printed circuit board 6 and through a cut-out 15 in the cooling body 10, the cut-out 15 being concentrically arranged in the axial direction, into a sleeve 21 that is arranged in the cut-out 15. The sleeve 21 can have an internal thread 22 for a mechanical connection to the screw 7. An electrical connection to the conductor section 20 is provided by way of the sleeve 21, whereby the connection between the sleeve 21 and the conductor section 20 can be realized by welding, pressure, screwing or a flexible conductor and the like.

In some embodiments, the conductor section 20 can also have a threaded hole with an internal thread, with the result that the additional sleeve 21 can be omitted. In some embodiments, the conductor section 20 can also protrude through the recess 9 and the cut-out 15 and have an external thread at its end. A nut can then be screwed onto this, said nut providing a mechanical connection between the component 1 and the conductor section 20.

In order to keep the pressure applied by the screw head to the printed circuit board 6 as low as possible, a washer 8 and/or a contact disk can be provided which distributes the force that is applied by the screw head of the screw 7 over a large area on the circuit board 6.

Moreover, the schematic illustration in FIG. 2 shows that the cooling body 10 comprises at least one fluid channel 14 for guiding a cooling fluid, for example (deionized) water and the like. Although the fluid channel 14 runs in the radial direction in the illustration shown, the fluid channel 14 (or the fluid channels) can also run in the axial direction or in a meandering manner. Combinations thereof are also possible. Flanges as inflow and outflow for the cooling fluid are not illustrated.

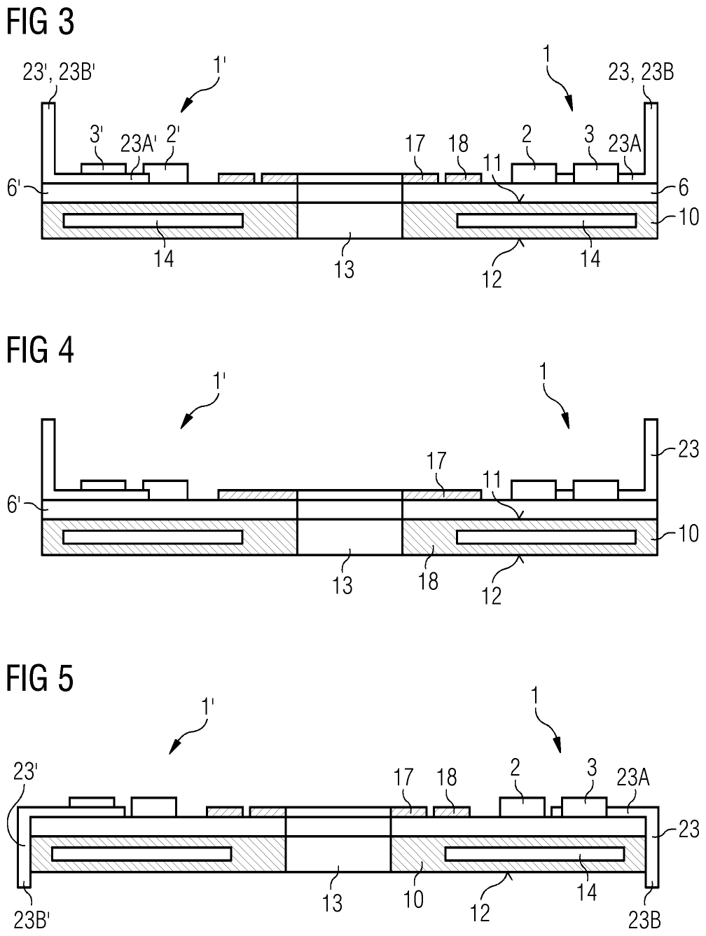

FIG. 3 illustrates a second exemplary embodiment in a schematic cross-sectional view. The illustration shows again the cooling body 10, on the first side 11 of which in the illustration shown an electronic power component 1 and 1′ is attached on both sides of the inner hole 13. Below the respective electronic power components 1, 1′, the cooling body 10 is provided with respective fluid channels 14 (that run in the radial direction, for example).

On the side facing away from the cooling body 10 of a respective printed circuit board 6, 6′, the already mentioned conductors 17 and 18 are attached as an example adjacent to the inner hole 13 as annular and concentrically arranged metal surfaces. The semiconductor switches 2, 3 or 2′, 3′ are apparent in each case in the radial direction in the direction of the outer circumference. The electrical contacting of the conductor sections 20 (not illustrated) is carried out by means of L-shaped connecting pieces 23, wherein a limb that is denoted by the reference numeral 23A, 23A′, for example by screwing, provides a contact to a circuit track structure of the electronic power component 1, 1′. A limb 23B, 23B′ which extends in the axial direction of the rotor (which extend perpendicular to the surfaces of the cooling body 10 and the printed circuit boards 6, 6′ of the components 1, 1′) is used for electrically contacting the associated conductor sections 20, not illustrated here. The attachment can be produced by welding, screwing or pressure.

The annular conductors 17, 18 form a DC bus, wherein, for example, the conductor 17 realizes a positive electrical DC voltage and the conductor 18 realizes a negative electrical DC voltage supply.

The exemplary embodiment illustrated in FIG. 4 differs from that in FIG. 3 in that only the conductor 17 is arranged on the circuit boards 6, 6′. The cooling body 10 forms the second conductor 18 and realizes a negative electrical DC voltage supply. In this embodiment variant, it is necessary that the cooling body 18 is separated at least in sections from the electronic power components 1, 1′ by way of an electrical insulation material. This can be realized, for example, by the carrier plates of the circuit boards 6, 6′ or a separately realized insulation layer.

The exemplary embodiments illustrated in FIGS. 3 and 4 have in common that the first side 11 of the cooling body 10 having the components 1, 1′ that are fastened thereon faces the rotor. In contrast, FIG. 5 shows a slightly modified embodiment variant in which the rotor faces the second side 12 of the cooling body 10. This means that the components of the power electronics, in other words the electronic power components 1, 1′, face away from the rotor.

To establish an electrical connection to the conductor sections 20, the sections 23B, 23B′ face in the direction of the stator and are optionally (as illustrated in FIG. 5) guided past the outer circumference of the cooling body and/or fed through the inner bore 13. In some embodiments, the sections 23B, 23B′ can also be fed through slits or dedicated cut-outs (not illustrated). The inner hole 13 could then be omitted. This is dependent upon where the conductors 17, 18 that are required so as to supply the DC voltage are arranged. Since said conductors are arranged in the exemplary embodiment illustrated in FIG. 5 in a concentric manner around the inner hole and adjacent to the inner hole 13, the limbs 23B, 23B′ are guided past the outer circumference. This could however also be reversed.

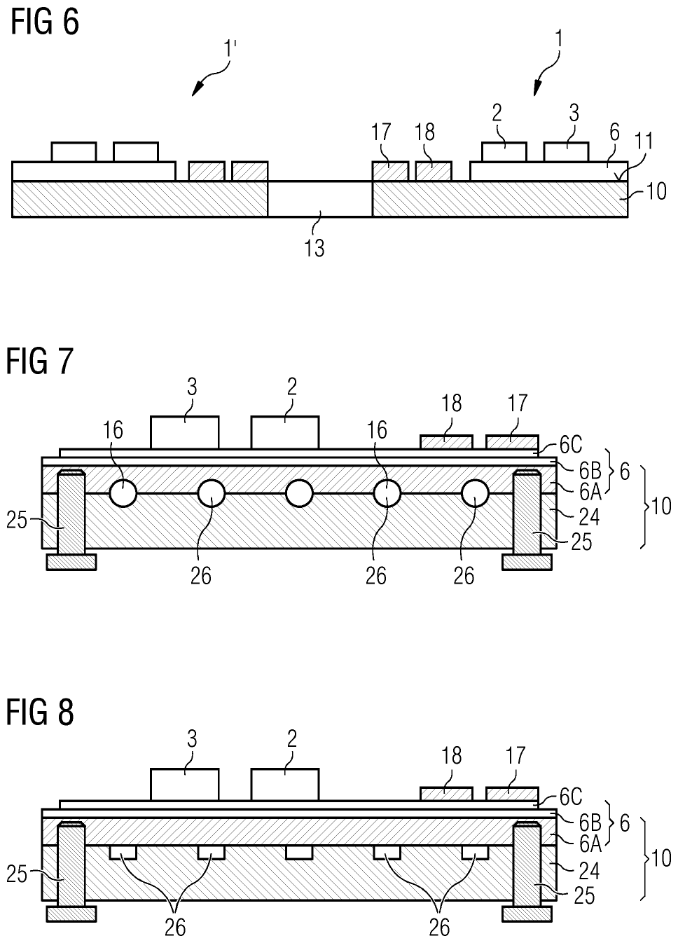

FIG. 6 illustrates an exemplary embodiment wherein the conductors 17, 18 are not attached to the carrier of respective electronic power components 1, 1′ but rather are attached directly to the cooling body 10. For this purpose, either the cooling body 10 is to be manufactured from an electrically insulating material or an insulating layer is to be provided between the conductors 17, 18 and in the cooling body 10.

In some embodiments, the conductors 17, 18 can be arranged insulated from one another one above the other. The conductor stack could be arranged directly on the cooling body 10 or on the printed circuit board 6.

FIGS. 7 and 8 illustrate exemplary embodiments wherein the printed circuit board 6 is a component of the cooling body 10. For this purpose, in the exemplary embodiment shown in FIG. 7, the already mentioned carrier plate 6A of the printed circuit board 6 has a number of cooling grooves 16 that are open on one side. Corresponding to this, a counter plate 24, which is screwed to the carrier plate 6A of the printed circuit board 6, has a corresponding number of cooling grooves 26 that are open on one side. This produces, merely as an example, a number of circular cooling channels. The connection of the carrier plate 6A and the counter plate 25 is performed as an example by means of a number of screws 25. The mechanical connection of the carrier plate 6A and the counter plate 24 can be performed in a different manner, for example adhesive, welding, riveting, positive-locking elements, etc.

In addition to the carrier plate 6A, the printed circuit board 6 comprises an insulating layer 6B and a conducting track structure attached thereto. In this exemplary embodiment, the semiconductor switches 2, 3 and the two conductors 17, 18 so as to supply the DC voltage are then arranged on the conducting track structure 6C. The carrier plate 6A, the insulator 6B and the conducting track structure 6C form together the already mentioned printed circuit board 6.

In the exemplary embodiment illustrated in FIG. 8, only the counter plate 24 has cooling grooves 26 that are open on one side. These are embodied in a rectangular manner in the exemplary embodiment. Likewise, only the carrier plate 6A could have cooling grooves that are open on one side, whereas the counter plate 24 comprises no cooling grooves.

The cross-sectional gap between the cooling grooves can be of any useful dimensions. Likewise, an arbitrary combination of different cross-sections of cooling grooves can be provided in one embodiment. Moreover, it is possible to provide only cooling grooves in sections in the carrier plate 6A and on other sections to provide only cooling grooves in the counter plate 24.

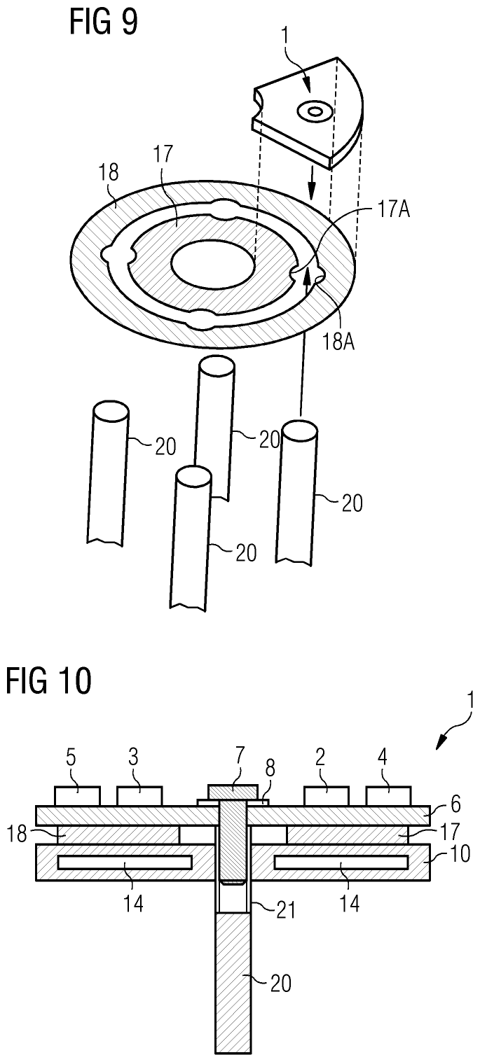

FIG. 9 illustrates an exploded perspective view without a cooling body, wherein the conductors 17, 18 are arranged below the electronic power components 1. This is best viewed in the associated cross-sectional view shown in FIG. 10. In the already described manner, the semiconductor switches 2, 3, the optional driver circuit 4 and the electronic component 5 (capacitor) are attached to the printed circuit board 6 of the electronic power component. The two conductors 17, 18 are arranged on the opposite side of the printed circuit board. Merely as an example, a connection is provided between the printed circuit board 6 of the component 1 and the cooling body 10 by a screw connection (not illustrated) that is provided between the conductors 17, 18.

In order to be able to embody the conductors 17, 18 over as large an area as possible, these can have respective cut-outs 17A and 18A in the region of the screw connection (cf. FIG. 9). Moreover, the screw connection is provided as described in conjunction with FIG. 2. The conductor section 20 is contacted merely as an example by way of the already described sleeve 21 that renders the screw connection possible. The sleeve 21 is supported in this case from below on the printed circuit board 6. The connection between the conductor section 20 and the sleeve 21 can be provided by screwing, welding, pressing, soldering or pressure.

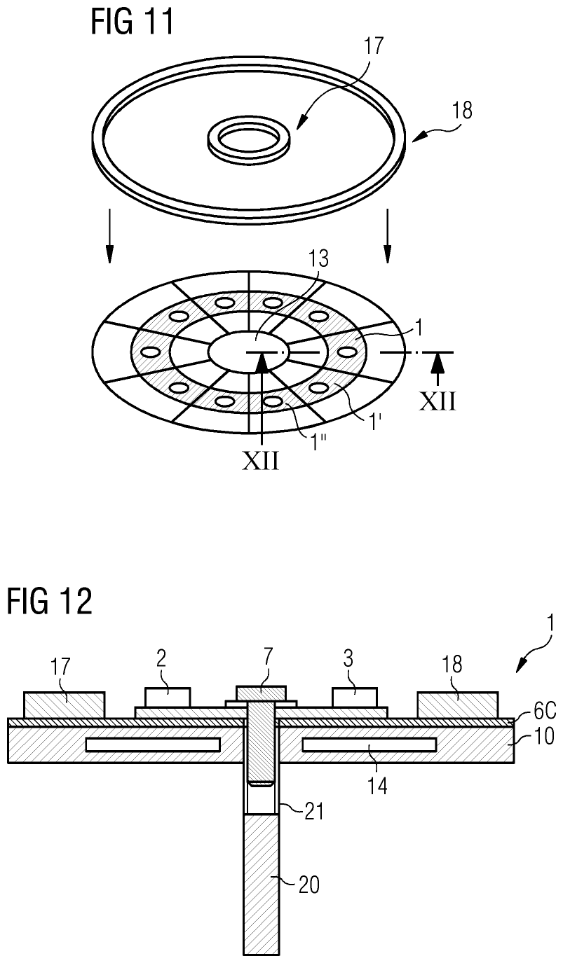

FIG. 11 illustrates an exemplary embodiment, wherein the components of the electronic power component are arranged between the concentrically arranged annular conductors 17, 18, wherein the conductors 17, 18 are arranged on the conducting track structure 6C of the printed circuit board 6 (FIG. 12). As a result, the conductors 17, 18 and the electronic components of the electronic power component 1 come to lie approximately in a plane that extends perpendicular to the axial direction of the stator. The connection between the electronic power component, in other words its printed circuit board 6 and the cooling body 10 and the conductor sections that are arranged behind, is performed as described in conjunction with FIGS. 2 and 10.

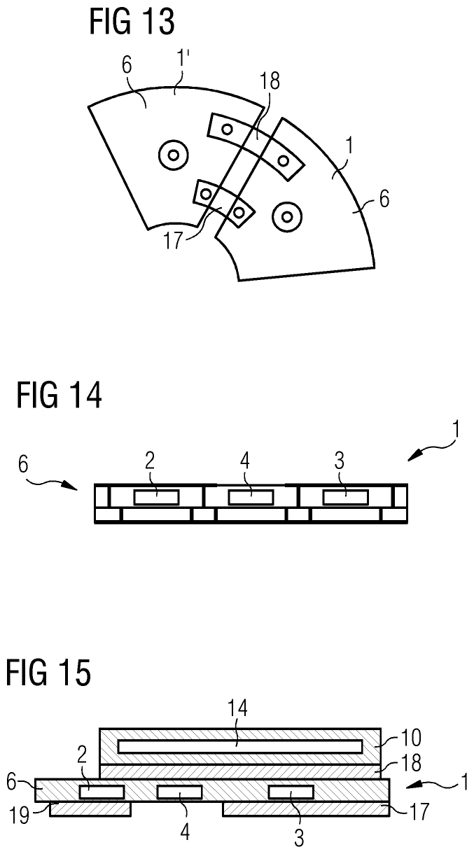

FIG. 13 illustrates an exemplary embodiment, wherein the conductors 17, 18 are not embodied in an annular manner but rather are guided as conducting track sections from an electronic power component 1 to the adjacent electronic power component 1′ As a result, a larger area is available for attaching electronic components to the printed circuit boards 6 of the components 1, 1′.

FIG. 14 illustrates an embodiment wherein the semiconductor switches 2, 3 and the optional driver circuit 4 are arranged in the interior of a multi-layer printed circuit board 6. As a result, it is possible to provide the conductors 17, 18, 23 over a large area on both surfaces that lie opposite one another.

In the exemplary embodiment that is illustrated in FIG. 15, the conductor 17 and a further conductor 19, in other words an AC voltage conductor, are attached on a lower side in the leaf plane. The conductor 18 is arranged on the upper side of the conductor plane 6 in the leaf plane. In turn, the already described cooling body 10 is arranged on the conductor 18.

In order to avoid vibrations being transmitted from the conductor sections 20 to the electronic power component 1, it can be expedient to connect the conductor sections 20 by way of flexible wires, cables or conducting cables to corresponding contact parts (screws, sleeves, connecting pieces). In some embodiments, the semiconductor switches 2, 3 and the optional driver circuit 4 can be provided on both sides with a cooling body.

In some embodiments, the electronic power component 1 can be attached in advance to the electronic components (semiconductor switches 2, 3 and the optional driver circuit 4) on the cooling body 10.

Furthermore, combinations of the said variants are possible. In some embodiments, the semiconductor switches are power semiconductors. In this case, various transistor variants can be used, in particular IGBTs, MOSFETs, JFETs, etc.

### LIST OF REFERENCE NUMERALS

1 Electronic power component
2 Semiconductor switch
3 Semiconductor switch
4 Driver circuit
5 Electronic component
6 Printed circuit board
6A Carrier plate
6B Insulator
6C Conducting area/conducting track structure
7 Screw
8 Washer
9 Hole/Cut-out
10 Cooling body
11 First side of the cooling body
12 Second side of the cooling body
13 Cut-out/Inner hole
14 Fluid channel
15 Cut-out
16 Cooling groove
17 Conductor (DC-Bus)
17A Cut-out
18 Conductor (DC-Bus)
18A Cut-out
19 Conductor (AC)
20 Conductor section
21 Sleeve
22 Inner thread
23 Connecting piece (L-shaped)
24 Counter plate
25 Screw
26 Cooling groove

What is claimed is:

1. An electric machine comprising:
a stator with a plurality of grooves for receiving a stator winding;
a respective conductor section of the stator winding is inserted into each groove of the plurality of grooves;
the respective conductor sections of a pole pair are short-circuited with one another on a first side of the stator;
each of the conductor sections is connected on a second side of the stator opposite the first side to a connection of a power supply unit;
the power supply unit comprises two conductors electrically connected to an electronic power component;
the electronic power component is arranged on a cooling body at least partially covering the second side of the stator.

2. The electric machine as claimed in claim 1, wherein the cooling body comprises a fluid channel for conveying a fluid.

3. The electric machine as claimed in claim 2, wherein the two conductors are annular at least in sections.

4. The electric machine as claimed in claim 1, wherein a first one of the two conductors is arranged on the cooling body.

5. The electric machine as claimed in claim 1, wherein a first one of the two conductors is arranged together with the electronic power component on a first side of the cooling body.

6. The electric machine as claimed in claim 1, wherein a first one of the two conductors is arranged on a second side of the cooling body lying opposite the first side.

7. The electric machine as claimed in claim 1, wherein the cooling body forms a first one of the two conductors.

8. The electric machine as claimed in claim 1, wherein the electronic power component comprises a printed circuit board with a semiconductor switch.

9. The electric machine as claimed in claim 8, wherein a first one of the two conductors is arranged on the printed circuit board.

10. The electric machine as claimed in claim 8, wherein the first one semiconductor switch and a driver circuit are arranged on and/or in the printed circuit board.

11. The electric machine as claimed in claim 8, wherein the first one semiconductor switch includes a surface mountable component.

12. The electric machine as claimed in claim 8, wherein the printed circuit board forms at least a part of the cooling body.

13. The electric machine as claimed in claim 12, wherein
the printed circuit board includes a cooling groove open on a first side;
the printed circuit board is connected on the first side to a counter plate.

14. The electric machine as claimed in claim 8, wherein the conductor sections are increased in length by an assigned cut-out in the cooling body and in the printed circuit board to be electrically connected on the side of the cooling body facing away from the stator to the one electronic power component.

15. The electric machine as claimed in claim 1, wherein the conductor sections are connected by an inner hole of the cooling body and/or outside the outer circumference of the cooling body by connecting pieces to the electronic power component.

16. The electric machine as claimed in claim 1, wherein the cooling body includes a plurality of segments including a number of segments corresponding to a count of phases.

17. The electric machine as claimed in claim 1, wherein a respective electronic power component controls one or more phases.
